(19) United States
(12) Patent Application Publication
(10) Pub. No.: US 2022/0152937 A1
(43) Pub. Date: May 19, 2022

(54) Apparatus and Method to Determining Nozzle Health in 3D Printing

(71) Applicant: Hewlett-Packard Development Company, L.P., Spring, TX (US)

(72) Inventors: Leticia Rubio Castillo, Sant Cugat del Valles (ES); Yngvar Rossow Sethne, Sant Cugat del Valles (ES); Jordi Raventos Catasus, Sant Cugat del Valles (ES); Adrien Chiron, Sant Cugat del Valles (ES)

(73) Assignee: Hewlett-Packard Development Company, L.P., Spring, TX (US)

(21) Appl. No.: 17/418,785

(22) PCT Filed: Aug. 5, 2019
(86) PCT No.: PCT/US2019/045063

§ 371 Date: Jun. 26, 2021

(51) Int. Cl. B29C 64/393; B33Y 10/00; B33Y 30/00; B33Y 50/02; B28B 17/00; B22F 10/85

(52) U.S. Cl. CPC B29C 64/393; B33Y 10/00; B22F 10/85; B33Y 50/02; B28B 17/0081; B33Y 30/00

(57) ABSTRACT

A method is disclosed in which print instructions for a 3D print job are received which including a plurality of layers to be printed on a layer-by-layer basis to form a 3D object. The print instructions are executed using at least one nozzle whilst performing a nozzle test in a plurality of layers of the 3D print job. The nozzle test results for each layer of the plurality of layers is compared to stored nozzle data. A current nozzle health status is determined based upon the comparison. A corrective action is triggered if the health status is non-compliant with a pre-determined threshold. An apparatus and a machine-readable storage medium comprising instructions executable by a processor are also disclosed.

### BACKGROUND

Print systems, including 2D and 3D print systems, may use printheads to dispense printing fluid, such as print agents, onto a substrate such as a piece of media or a layer of build material. Print heads may have very high resolution (for example 1200 dpi) and may comprise an array of small nozzles. To ensure print quality it may be important to maintain the printhead. For example, maintenance actions may be taken to maintain nozzles “alive” and actions may also ensure that “dead” (for example damaged or clogged) nozzles are not used (for example using alternate or adjacent nozzles). As such various maintenance and/or calibration strategies may be applied to printhead nozzles.

3D print systems use printheads to deposit print agent onto a layer of build material to generate successive layers of a 3D object.

### BRIEF DESCRIPTION OF THE DRAWINGS

Various features of the present disclosure will be apparent from the detailed description which follows, taken in conjunction with the accompanying drawings, which together illustrate features of the present disclosure, and wherein:

FIG. 1 is a schematic example of a 3D print apparatus; and

FIG. 2 is a schematic flow chart showing an example of a method to determine nozzle health in 3D printing.

### DETAILED DESCRIPTION

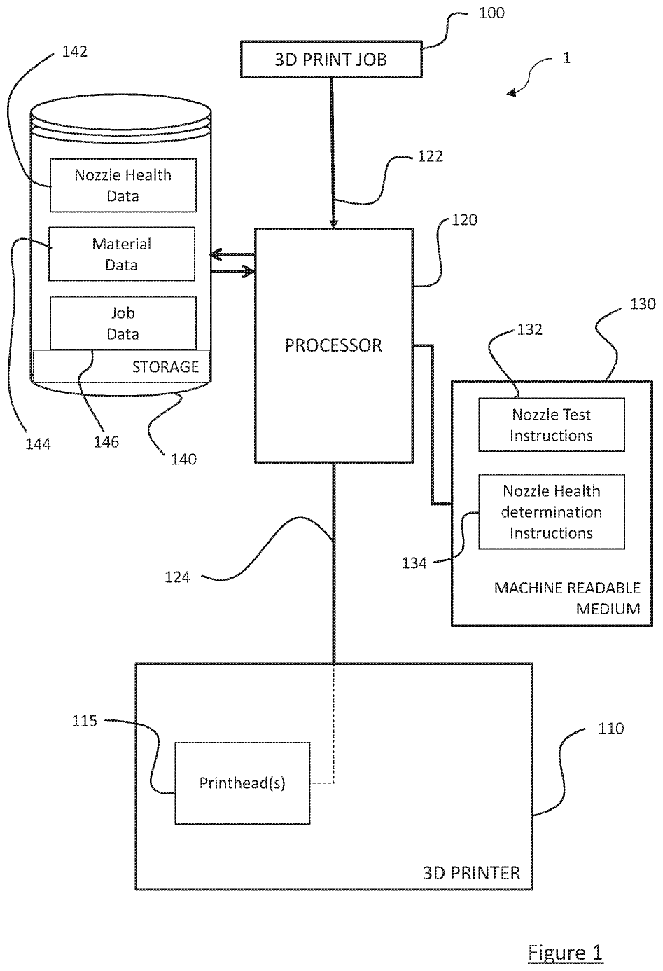

An apparatus 1 for 3D printing is shown in FIG. 1. The apparatus includes a 3D printer 110 which includes at least one printhead 115 for depositing print agent on a layer of build material. A processor 120 is provided to receive a print job and to control the 3D printer 110 to execute the print job. The printhead 115 may include an array of nozzles and may, for example, be provided in a carriage of the 3D printer 110. The processor 120 may have an input 122 to receive a print job 100, for example from a user interface, computer or network. In some examples, the print job 100 may be provided to the apparatus 1 as a set of print job instructions (for example a series of instructions for the layer-by-layer print). In other examples, the print job may be sent to the apparatus 1 as a 3D object model and the processor may determine a corresponding set of print job instructions. The processor may also include an output 124 for communication with the 3D printer 110. The processor 110 communicates with a machine-readable storage medium 130 which includes instructions to be implemented by the processor 110 and a storage 140 including data to be accessed by the processor 110.

The processor 120 may be a central processing unit (CPU), a semiconductor-based microprocessor or any other device suitable for retrieval and execution of instructions. As an alternative or in addition to fetching, decoding, and executing instructions, the processor 120 may include one or more integrated circuits (ICs) or other electronic circuits that comprise a plurality of electronic components for performing the functionality described herein. The functionality described herein may be performed by multiple processors. The processor 120 may provide a service to a single 3D printer or may be used for a plurality of 3D printers (and may be a cloud-based service). In one implementation, the processor 110 is part of the 3D printer 110, such as where the processor 120 manages additional operations of the 3D printer 110.

The processor 120 may communicate with the machine-readable storage medium 130. The machine-readable storage medium 130 may be any suitable machine readable medium, such as an electronic, magnetic, optical, or other physical storage device that stores executable instructions or other data (e.g., a hard disk drive, random access memory, flash memory, etc.). The machine-readable storage medium 130 may, for example, be a computer readable non-transitory medium. The machine-readable storage medium 130 may include instructions to be executed by the processor (as explained further below). The machine-readable storage medium 130 may for example include nozzle test instructions 132 and nozzle health determination instructions 134.

The storage 140 may be any convenient store and can without limitation include local files, web storage, databases and/or FTP servers. The storage 140 stores data which may include nozzle health data 142, material data 144 and/or print job data 146. The nozzle health data 142 may for example be comparative nozzle health data. The nozzle health data 142 may for example include one or more of: historical nozzle data, calculated or simulated nozzle data and/or nozzle design or specification data. The processor 120 may read and/or write to the storage media 130. For example, the nozzle health data 142 may be accumulated through the use of the 3D print system 1.

The printer may provide a layer or bed of build material onto which printing agents can be selectively deposited by the printhead 115. The printhead 115 may be arranged in a carriage such that the carriage can be passed over the layer or bed of powder whilst making precise multiple deposits across the build material. The printhead may for example deposit one or more of fusing agent, detailing agent and/or coloring agent. The layer may subsequently be exposed to an energy source to complete the selected fusion of the layer to form a solid substantially 2D slice of the 3D part. The printer may then repeat the print process on a layer-by-layer basis until the full 3D part has been printed.

The build material may for example be a powder. Powdered build material may be used to refer to wet or dry powder, particulate materials, and granular materials. Powdered build material may be made from many suitable materials, for example, powdered metallic materials, powdered composite materials, powdered ceramic materials, powdered resin materials, powdered glass materials, powdered polymer materials and the like. In some examples, powdered build material may be formed from, or may comprise, short fibers that may, for example, have been cut into short lengths from long strands or threads of material. Short fibers may be metallic fibers, polymer fibers, ceramic fibers, or other suitable fiber materials.

Examples of build materials for additive manufacturing include polymers, crystalline plastics, semi-crystalline plastics, polyethylene (PE), polylactic acid (PLA), acrylonitrile butadiene styrene (ABS), amorphous plastics, Polyvinyl Alcohol Plastic (PVA), Polyamide (e.g., nylon), thermo(setting) plastics, resins, transparent powders, colored powders, metal powder, ceramics powder such as for example glass particles, and/or a combination of at least two of these or other materials wherein such combination may include different particles each of different materials or different materials in a single compound particle. Examples of blended build materials include alumide, which may include a blend of aluminum and polyamide, and plastics/ceramics blends.

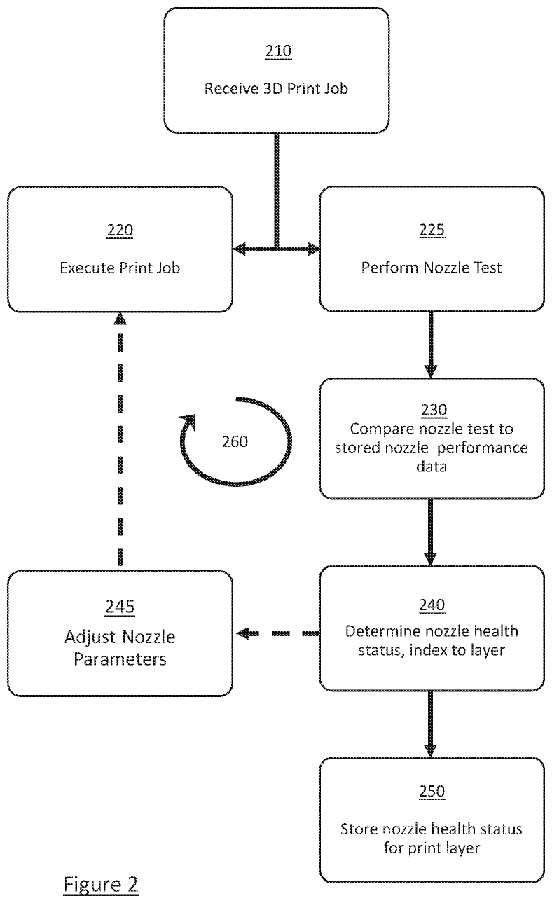

The operation of an example will now be described with reference to the flow chart of FIG. 2. It will be appreciated that the method shown in FIG. 2 may be implemented in the machine-readable instructions 132 and 134 of FIG. 1 and executed by the processor 120 on the system 1. The method may be initiated by a set of print instructions for a 3D print job being received in block 210. The print job may include a plurality of layers to be printed on a layer-by-layer basis to form a 3D object. The processor 120 may use the 3D printer 110, to execute the print instructions in block 220. This causes the printhead 115 to be used to deposit material on a layer-by-layer basis.

In accordance with the disclosure the processor may also perform a nozzle test 120 on the at least one nozzle 115 in block 225. The nozzle test in block 225 may, in one example, be concurrent to the print build in block 220. In particular, the nozzle test can be performed during processing of a selected plurality of layers of the 3D print job. For each selected layer in which the nozzle test is performed, in block 225, a comparison may be made, in block 230, between the nozzle test results and stored nozzle health data 142 which may be held in the store 140. The comparison may be used in block 240 to determine a current health status of the nozzles. As noted above, a print head may include a plurality of nozzles, for example an array of nozzles. In some examples of the invention the nozzle test performed during processing of a selected plurality of layers may be performed on all of the nozzles in the printhead.

The current health status is specific to the selected layer of the build in which the nozzle test was performed. The nozzle health status may, therefore, be indexed by both nozzle and layer of the build. Indexing may provide a record of the nozzle health through the build which can be reviewed or tracked. For example, the indexing may allow the nozzle health status for a nozzle to be compared or reviewed across a number of layers of a print. The indexed data may, for example, be stored as part of the job data 146 of the store 140. The health status may effectively be a “real time” health status at the point of the build in which the nozzle test was carried out. In some examples, this may allow the health of the printhead nozzles to be monitored or tracked throughout a part build.

Indexing nozzle health results by nozzle and layer may, in some examples, be used to determine corresponding regions of the part which were printed or remain to be printed with the nozzle in the tested health status. For example, as a digital model the 3D object to be printed may consist of a number of voxels. The voxels may map (although not necessarily on a one-to-one basis) to corresponding areas of the printed 3D object which may lie in at least one layer of the print (or more than one layer if the layer thickness is less than the voxel size). The location of the areas on the 2-dimensional layer may provide a correlation between the printhead nozzles and the area of the 3D object. As such, some examples the health status from the nozzle test can be mapped onto specific regions of the printed 3D part and/or can be represented in a 3D model of the part.

Since nozzle health can directly impact resulting print quality, examples may further include triggering a corrective action when the health status is non-compliant with a predetermined threshold (as will be explained further below). The corrective action may include notifying or flagging that an object (or region of an object) which has been printed may have quality issues as a result of nozzle health. The corrective action may include corrective or preventative action to maintain print quality above a certain threshold. Print quality may, for example, be determined based upon one or more of dimensional accuracy, mechanical properties and look and field of the 3D object being printed. In block 245 the print parameters of the at least one nozzle may be adjusted by the controller 120. This can be fed back into the execution of the print job in block 220 (for example for subsequent layers of the print job that remain to be printed in block 220). As shown by arrow 260, the nozzle test, comparison and health status determination may be repeated throughout the execution of the print job.

Whilst the nozzle test could be performed on every layer of the 3D print job this may incur excessive time and/or processing power and/or material consumption. In some examples, the nozzle test may be repeated at fixed layer intervals. For example, the nozzle may be tested during the 3D print job at a fixed interval—for example a nozzle test may be performed every 5, 10 or N layers throughout the build of the print job. Performing repeated tests may be beneficial since print characteristics can vary greatly on a layer by layer basis of a 3D print job. The print characteristics of a 2D layer may for example differ from other layers of the same object by having a larger portion of printed features and/or having more detailed features and/or in having more complex 2D geometry. Further the layer-by-layer nature of 3D print jobs may cause the print process to take a considerable time period (for example several hours) during which at least some nozzles may be in substantial use. The interval at which the nozzle test is to be performed may be selected based upon properties of the build, for example the material being used in the build or the part geometry (for example the size and or print density of the part). The material data 144 and or the job data 146 of the storage 140 may for example be interrogated by the processor 120 to select an appropriate test interval for a print job 100. In some implementations a user interface may allow the user to select or adjust a test strategy, for example increasing or decreasing the test interval.

The processor 120 may include a nozzle test in the first layer of the print job. By performing a nozzle test on the printhead whilst processing the first layer of the print a baseline or initial nozzle health status may be provided. In some examples, such a baseline or initial health status may then be incorporated into the comparison of the nozzle health (for example to enable the nozzle health trends during a specific print job).

The nozzle test may be a nozzle drop detection test. For example, the or each nozzle of the printhead 115 may be instructed to dispense a drop of fluid onto a sensor or drop detector with a predetermined precision. If the precision of the drop (for example the speed or volume of the dispensing) is below the intended performance criteria this may, for example be noted as a test result which is below a required threshold. The sensor or drop detector can provide a resulting signal for processing and comparison with the stored nozzle health data 142. The nozzle test data may also be added to the nozzle health data 142 to provide an ongoing updated database.

In some examples the nozzle health status could be designated on a scale for example a numeric or percentage being assigned indicative of how healthy or close to failure a nozzle is determined to be. In some examples, the nozzle health status from the comparison in block 230 may for example be categorized in block 240 in one of a number of statuses. For example, a nozzle could be flagged as one of several states, such as one selected from a list including “healthy”, “failing”, “possibly dead”, “almost dead” and “completely dead”. The “healthy” status may indicate that the drop test was within expected or design specifications for the nozzle. The “failing” status can correspond to contradictory information from drop detector for a specific nozzle in the last nozzle test runs. The “possible dead” status can correspond to non-consecutive drop detections which have given some signals warning a possible nozzle issue. The “almost dead” status may indicate that the nozzle is not firing in most of the last drop detections. The “completely dead” status may represent a nozzle which is not firing in the last “n” drop detections (where n may be a predetermined threshold for the number of failed tests, for example based upon historical test data).

The results of the nozzle test may be recorded in block 250, for example being written to the storage 140 and/or being sent to a user interface. This may enable a user to track the nozzle performance over one or more print jobs. Keeping a record of nozzle performance during the print job (for example on a layer-by-layer basis or an Nth layer basis) can allow a user to identify parts or regions of parts produced by the 3D print process that may benefit from quality control inspection. In some examples, a flag (for example a visual and/or electronic warning or notification) may be issued to a user when the health status for the 3D print job is below a predetermined threshold which is considered to present a risk to the print quality. For example, such a flag could be triggered based upon the number of nozzle tests which indicate unsatisfactory health exceeding a threshold or by health status of nozzles which are mapped to a significant region of an object (for example a region with a high level of detailed features) being unsatisfactory.

In some examples recording the status of the nozzle to allow inspection and/or tracking of part quality may be sufficient. As mentioned above, in other examples the system may, additionally or alternatively, be used to take corrective or preventative action in block 245. The user may be provided with an option to switch between using either one or both of these options in a printer setup interface (or may be able to indicate the requirement in print instructions). The corrective or preventative action can include adjusting at least one print parameter (as explained in further detail below). The corrective or preventative action may be implemented for some or all of the subsequent layers of the print. The adjustment may for example be optimized by the processor 120 to improve, or maintain, one or more of dimensional accuracy, mechanical properties and look and field of the 3D object being printed. In some examples, the corrective or preventative action may be performed by adjusting at least one nozzle in an array in response to the nozzle health status of a neighboring, for example an adjacent, nozzle.

Adjusting the print parameters in block 245 may include adjusting fluids being deposited in the print process. The adjustments available may depend upon the configuration of the 3D printer 110, for example the type of printhead 115. The parameters may for example be adjusted to alter the quantity of the fluids, for example print agents, being deposited. In some examples it may be possible to adjust the drop size dispensed from the nozzle of a printhead. In other examples the drop size may be fixed but the volume of fluid the print head 115 delivers to a location on the print may be adjustable by controlling the number of drops dispensed by a nozzle and/or its adjacent nozzles of the print head 115.

In some examples, a number of pre-defined strategies may be included in the machine-readable instructions 130 so that the processor 120 can select appropriate action dependent upon the nozzle health status and the print instructions. For example, when the nozzle health status is found to be indicative that the print quality of the build may be adversely impacted, the processor 120 may consider the content of the current layer to be printed when selecting the corrective action. In some examples the processor 120 may also consider the print content of neighboring print layers (which may include one or both of previous printed content and/or posterior content which is to be subsequently printed) to select the most appropriate action.

In one example, if nozzle health is determined to be likely to impact an area of a print which includes important small scale features the processor 120 may instruct the printer 110 to increase the quantity of a detailing agent fired in the area. For example, the print instructions may be modified by the processor to cause additional detailing agent deposition to be extended to include immediately adjacent regions of the print. By increasing the footprint of the area over which the detailing agent is being deposited it may be possible to ensure that the area of the print with small features receives sufficient agent even if a nozzle which has been identified as having low health does not reliably provide that agent. In some examples, it may also be possible to recover a nozzle with low health status (for example indicating that it is “possible dead” or “almost dead”) by adjusting the print instructions to fire the nozzle with a higher frequency for a short period of time. This high frequency firing of the nozzle may help recover the nozzle. In some examples the increased frequency firing may be carried out with the increased footprint of agent deposition so as to improve the nozzle health and also offset any reduction in fluid dispensed.

In another example, if the nozzle health status indicates that several consecutive or proximal nozzles have a low health status (for example they are identified as “possible dead” or “almost dead” nozzles) a corrective action may need to consider how the consecutive nozzles will impact corresponding regions of the printed part. For example, a printed part may include a solid central region which comprises adjacent areas of printed material. If nozzle health status indicates that there are several consecutive or proximal nozzles with low health status the processor may compensate by increasing the overall fusing agent provided in the region (for example using neighboring nozzles). In this way the proper fusing of the central area of the part may be protected by the modified print instructions.

In some implementations the processor 120 may also use the print instructions 100 and/or stored print job data 146 to trigger corrective or preventative action in anticipation of the nozzle requirements in future layers of the 3D print job. For example, if nozzles are identified with low or deteriorating health status in a current layer and the print instructions indicate that those nozzles will be used intensively in subsequent build layers the processor 120 may initiate a preventive action. For example, ahead of subsequent build layers which are known to have high content for specific nozzles the processor 120 can adjust the print instructions to start firing those nozzles in earlier layers, in advance, to seek an improve the health status. For example, the nozzles may be pre-fired in non-required regions or layers. The quantity of print agent dispensed in such pre-firing may be set by the processor 120 to avoid or minimize any affect on the dimensional properties of the part being printed. For example, the volume of fusing agent may determine the extent to which the build material absorbs fusing energy and therefore the quantity used in pre-firing for any given region of the print may be kept below the level required to reach layer fusion.

A user of a print system may wish to have detailed cost information relating to 3D parts printed. As such, to provide greater accuracy in cost information the processor 120, in some examples, may also maintain a count of corrective or preventive adjustments made to the print fluid usage on a layer-by layer or part basis. The processor 120 may for example store a count in the job data 146 of the storage 140. As such, the user may be provided with an indication of the additional cost incurred (for example the additional print agent consumption). Such a count may allow the user to compare the part quality versus material consumption and/or processing time. A user may then use such stored job data 146 when making decisions on print parameters for subsequent builds (for example when deciding whether to build a given 3D object with “real time” nozzle monitoring and/or adjustment in active use).

It may be noted that when the nozzle 115 of the printer 110 is a nozzle array, implementations of this disclosure may specifically identify the relationship between a nozzle which is tested, and voxels of the part formed in the 3D print process. For example, the length of the nozzle array may match the number of rows of the bed image printed per layer. The nozzle health status determined by the system 1 may be provided as an array for each layer such that the health status can be mapped onto the voxels of the printed 3D object.

A print system 1 may implement the present disclosure in addition to other processes for addressing or maintaining nozzle health. For example, a nozzle spitting strategy in which the nozzles 115 of the 3D printer 110 are periodically purged (for example prior to each layer of the build) may be used. Such nozzle cleaning may, for example, be done across the print area (in a way that the purged droplets impact on print quality is minimized or managed, for example in areas of the print bed not occupied by the printed part) or into a dedicated spittoon.

Whilst the example above has been described with reference to a 3D print apparatus and method, it may be possible to implement some examples in 2D print apparatus and methods.

The preceding description has been presented to illustrate and describe examples of the principles described. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

What is claimed is:

1. A method comprising:
receiving a print job to print a 3D object,
executing print instructions defining a plurality of layers of build material to be printed on a layer-by-layer basis by at least one printhead to form a 3D object;
performing a nozzle test on the printhead during printing of a first selected layer of the plurality of layers;
repeating the nozzle test during printing of further selected layers of the plurality of layers;
comparing the nozzle test results for each of the selected layers to stored nozzle data and determining a nozzle health status, based upon the comparison; and
triggering a corrective action when the health status is non-compliant with a predetermined threshold.

2. The method of claim 1, further comprising indexing the health status by nozzle and layer.

3. The method of claim 1, wherein triggering a corrective action comprises alerting a user when the health status for the print job is below a predetermined threshold.

4. The method of claim 1, wherein triggering a corrective action further comprises:
adjusting at least one print parameter for subsequent print layers of the print job in response to the nozzle health status.

5. The method of claim 3, wherein executing the print instructions comprises depositing at least one print agent from the printhead and wherein adjusting at least one print parameter comprises adjusting the quantity of print agent deposited.

6. The method of claim 1, further comprising comparing the nozzle health status to the print instructions for the 3D print job to predict the impact of current nozzle health on subsequent layers to be printed on a layer-by layer basis.

7. The method of claim 1, wherein the first selected layer of the plurality of layers is the first print layer and the further selected layers comprises layers at fixed layer intervals on subsequent layers of the print job.

8. The method of claim 6, wherein the fixed layer intervals are selected based upon print job characteristics.

9. The method of claim 7, wherein the fixed layer intervals are dependent upon the print material.

10. The method of claim 1, wherein the printhead comprises an array of nozzles and the method further comprises adjusting at least one print parameter of at least one nozzle in the array in response to the nozzle health status of a neighboring nozzle.

11. The method of claim 1, wherein the method further comprises counting nozzle material usage for the 3D print job.

12. An apparatus comprising:
a 3D printer comprising at least one printhead;
a processor comprising:
an input to receive a 3D print job, said print job defining a plurality of layers of build material to be printed on by the printer on a layer-by-layer basis to form a 3D object;
an output to issue control commands to the 3D printer; and
a machine-readable medium comprising instructions executable by the processor to
execute a nozzle test on the printhead during printing of a first selected layer of the plurality of layers to be printed,
repeat the nozzle test on the printhead during printing of further selected layers of the plurality of layers;
compare the nozzle test results for each layer of the plurality of layers to stored nozzle data and determine a current nozzle health status, based upon the comparison, and
trigger a corrective action when the health status is non-compliant with a predetermined threshold.

13. An apparatus as claimed in claim 12, further comprising a storage to store one or more of: comparative nozzle test data, material or print parameter data and print job data.

14. An apparatus as claimed in claim 11, wherein the corrective action includes one or more of issuing a notification or flag or adjusting the print instructions of subsequent layers of the print job.

15. A machine readable storage medium comprising instructions executable by a processor to:
receive a 3D print job, said print job including a plurality of layers to be printed by a 3D printer on a layer-by-layer basis to form a 3D object;
instruct at least one printhead of the 3D printer to execute said print job and to perform a nozzle test on the printhead in a plurality of layers of the 3D print job;
determining a current nozzle health status, based upon a comparison of the nozzle test results to stored nozzle test data, and
trigger a corrective action when the health status is non-compliant with a predetermined threshold.
